(19) United States
(12) Patent Application Publication
(10) Pub. No.: US 2020/0302428 A1
(43) Pub. Date: Sep. 24, 2020

(54) Secure Biometric Card and Method for Securing Information

(71) Applicant: JPMorgan Chase Bank, N.A., New York, NY (US)

(72) Inventors: Ankur Sambhar, Thane West (IN); David M. Snyder, Urbana, OH (US)

(21) Appl. No.: 14/955,506

(22) Filed: Dec. 1, 2015

(51) Int. Cl. G06Q 20/36; G06Q 20/40

(52) U.S. Cl. CPC G06Q 20/363; G06Q 20/4012; G06Q 20/40145

(57) ABSTRACT

Embodiments of the presently disclosed invention provide a secure card device and associated method for operation. In particular, embodiments provide a secure card device facilitating protection of secure information belonging to a cardholder. The secure card device includes a biometric interface allowing the cardholder to self-authenticate to the card a memory storing instructions and information pertaining to the cardholder and a card body connected with the memory, the card body including at least one planar face for communicating the secure information belonging to the cardholder upon self-authentication by the cardholder through the biometric interface. The card device also includes a data release circuit for releasing the secure information upon self-authentication by the cardholder and a display controller responsive to the data release circuit for causing the secure information to be readable from the at least one planar surface of the card body.

### FIELD OF THE INVENTION

Embodiments of the invention are generally related to a secure card and a method for providing and utilizing the secure card, and in particular, for providing a secure bank card for protecting confidential cardholder information.

### BACKGROUND OF THE INVENTION

For many years, plastic cards having magnetic stripes have functioned as access devices and as standard payment vehicles for making purchases. Magnetic stripes storing secure information are typically affixed to a back face of a plastic card. Swiping the card in an electronic reading device reads the cardholder information. Such technology has been used both for access cards enabling entry of the cardholder into secure establishments, such as office buildings or hotel rooms, and for bank cards enabling cardholders to make purchases. In the case of bank cards, the electronic reading device typically sends the magnetic stripe data to the bank that issued the card. The bank computers verify that the cardholder has sufficient funds and approve or declines the request.

Magnetic stripe technology has remained popular due to its standardization throughout the industry and low cost of production. However, sophisticated fraudsters have evolved their techniques of cloning cards in order to perpetrate fraudulent transactions. Card writing devices used by fraudsters are readily available and relatively inexpensive. Furthermore, the secure details of the card are generally visible on the card itself. Thus, anyone recovering a lost card or coming into contact with a card for a brief period has the confidential details required to make purchases with the card. For online or other purchasing processes when the card is not required to be present, it is very easy for individuals acquiring the confidential details on the face of the card to make purchases using the card. Additionally, even with in-person transactions, most merchants do not require any authentication such as an identification card. Even a signature may only be required when the purchase is large.

Fraud has been widespread and therefore in Europe, magnetic stripe cards are often not accepted. Accordingly, industry standards have been evolving and shifting to chip based cards. Some of these cards may include transmitters that use technologies such as RFID technology to transmit data to a card reader in close proximity. Other cards use EMV technology. These cards include an Integrated Circuit Chip that comes into contact with a card reader to perform some type of authentication, such as by using a PIN or a signature.

Chip-based cards are currently used in a variety of applications including electronic payment transactions and access control applications. These cards are typically viewed as more secure than magnetic stripe cards. However, they are also vulnerable to fraud. In some instances authentication data for these cards is stored in systems and repositories that are vulnerable to hacking. Additionally, with cards using RFID technology, secure data can be compromised when it is erroneously transmitted to devices within close proximity. Chip based cards are not useful for fraud prevention in transactions when the card is not present, such as online or telephone purchases, since the data is simply read by the purchaser for input. Furthermore, both magnetic stripe cards and chip based cards can be lost or stolen.

Fraudulent charges create a tremendous amount of burden on financial institutions and cardholders. Within hours of fraudulently obtaining a card or secure card information, fraudsters can generate charges for many thousands of dollars before a notification procedure is fully executed for preventing further fraudulent activity.

Additionally, the shift from magnetic stripe cards to chip based cards as well as the constant evolution of the chip-based cards create a financial burden on the issuing institutions for providing the cards. A further financial burden is placed on merchants for supplying their portions of the underlying infrastructure for processing the cards. In the United States, issuers are separated from the payment processing system and therefore card issuers are not able to force merchants to acquire new terminals for processing new types of cards.

Accordingly, there is an essential need for a solution that can utilize the existing payment infrastructure including magnetic stripe readers and chip based readers while minimizing the likelihood of fraud.

### SUMMARY OF THE INVENTION

Embodiments of the invention provide a secure card device that can be used for both in-person and online transactions that conceals and protects confidential information on the card until the user of the card is authenticated. The authentication is required for both online and in-person purchases.

In one aspect of the present invention, a secure card is provided for facilitating protection of secure information belonging to a cardholder. The secure card includes a biometric interface allowing the cardholder to self-authenticate to the card, a memory storing instructions and information pertaining to the cardholder, and a card body connected with the memory. The card body includes at least one planar face for communicating the secure information belonging to the cardholder upon self-authentication by the cardholder through the biometric interface and a data release circuit for releasing the secure information upon self-authentication by the cardholder. The card further includes a display controller responsive to the data release circuit for causing the secure information to be readable from the at least one planar surface of the card body.

In another aspect of the invention, a method is provided for completing a secure transaction using a secure card for facilitating protection of secure information belonging to a cardholder. The method includes receiving input from the cardholder through a biometric interface on a card body, the card body including at least one planar face for communicating the secure information belonging to the cardholder upon self-authentication by the cardholder through the biometric interface allowing the cardholder to self-authenticate to the card. The method further comprises utilizing a memory connected with the card body, the memory storing instructions and information pertaining to the cardholder to compare the received input through the biometric interface to stored biometric information in order to authenticate the cardholder, and activating a data release circuit for releasing the secure information upon self-authentication by the cardholder. The method additionally includes causing the secure information to be readable from the at least one planar surface of the card body using a display controller responsive to the data release circuit.

In embodiments of the invention, the biometric interface includes a fingerprint reader. The secure information may include an account number and a cardholder name, and/or a card verification value (CVV) code. The release of data also includes unlocking data on a chip and/or magnetic stripe for a brief duration in order to facilitated point-of-sale transactions.

### BRIEF DESCRIPTION OF THE DRAWINGS

In order to facilitate a fuller understanding of the present invention, reference is now made to the accompanying drawings, in which like elements are referenced with like numerals. These drawings should not be construed as limiting the present invention, but are intended to be exemplary only.

FIG. 1 is a block diagram illustrating a secure card device in accordance with an embodiment of the invention;

FIG. 2 is a rear plan view of a secure card device in accordance with an embodiment of the invention;

FIG. 3 is a front plan view of a secure card device in accordance with an embodiment of the invention;

FIG. 4 is a front view of a secure card device prior to authentication in accordance with an embodiment of the invention;

FIG. 5 is a front view of the secure card device of FIG. 4 upon self-authentication by the cardholder;

FIG. 6A is a flow chart illustrating a card issuance process in accordance with an embodiment of the invention;

FIG. 6B is a flow chart illustrating a card issuance process in accordance with an alternative embodiment of the invention;

FIG. 7A is a flowchart illustrating a card activation process in accordance with an embodiment of the invention;

FIG. 7B is a flowchart illustrating a card activation process in accordance with an alternative embodiment of the invention and

FIG. 8 is a flowchart illustrating processing within the secure card device upon user self-authentication.

### DETAILED DESCRIPTION OF THE INVENTION

Embodiments of the disclosed invention provide secure card device and a method for utilizing the secure card device. In particular, embodiments provide a method for securing data stored on the secure card device and displayed on the secure card device so that neither ‘card present’ no ‘card not present’ transactions can be performed using the secure card device without proper authentication.

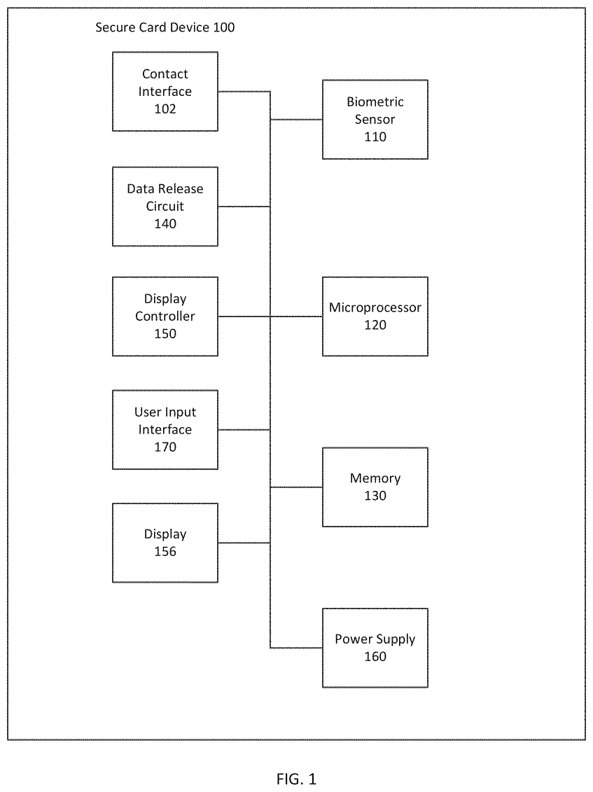

FIG. 1 is a block diagram illustrating components of a secure card device 100 in accordance with an embodiment of the invention. The secure card device 100 may be made from a plastic material and may include a contact interface 102, a biometric sensor 110, a microprocessor 120, a memory 130, a display controller 140, a data release circuit 150, a power supply 160, and a user input interface 170.

The card 100 may be formed from one or more plastic substrates or films and the components described below are embedded in the substrates or films. For example, a plastic substrate may have embedded components and may be protected on each planar surface by a protective flexible film.

The contact interface 102 may interface with an EMV contact chip with a contact module on its front. This contact module may have a size in the range of approximately 1 cm by 1 cm and may contain a chip at the back. The contact chip card may communicate with a reader. When inserted into the reader, electrical connectors of the reader contact the contact module for reading information from and writing information back to the chip card. Contact chip cards are, for instance, standardized by ISO/IEC 7816 or ISO/IEC 7810.

As will be described further below, in some embodiments of the invention, the contact interface 102 may include multiple contact mechanisms such as for interfacing with an EMV chip and for interfacing with a magnetic stripe. The secure card device 100 may optionally include a contactless interface. In a contactless chip card, the integrated circuit communicates with the reader in a contactless manner, for instance through Radio-frequency identification (RFID). Contactless chip cards are, for instance, standardized by ISO/IEC 14443 or ISO 15693.

The biometric sensor 110 preferably includes a fingerprint sensor. The fingerprint sensor may be formed from a conductive material such as, for example, indium oxide or indium zinc oxide. The biometric sensor 110 is accessible on an external face of the card and is connected to the power supply 160 so that the fingerprint sensor can be activated upon contact with a finger. In embodiments of the invention, the biometric sensor 110 may be mounted on a substrate surface and surrounded by a transparent protective film. Other configurations are within the scope of the invention. Any fingerprint sensor having appropriate characteristics for incorporation in a secure card device can be utilized. An example of a suitable fingerprint sensor is a tiny 0.2 mmm sensor produced by Seiko Epson. The sensor reads fingerprints by detecting the miniscule electric current from the finger of the user when the use ouches the sensor on the secure card device.

The microprocessor 120 receives data from the biometric sensor 110 and compares the received data with stored fingerprint data from the memory 130 in order to determine if the scanned fingerprint matches the stored fingerprint. The microprocessor 120 may be a programmed microprocessor as described, but may additionally or alternatively incorporate a micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices capable of implementing the steps of the processes of the invention.

In embodiments of the invention, the microprocessor is programmed to dynamically generate a new virtual account number for each transaction, such that a primary account number is never displayed. However, in other embodiments, the microprocessor allows use of the primary account number for each purchase. Additionally, the display of the new virtual account number may be achieved using a different method than the display of the primary account number. For example, to display a primary account number, the cardholder may be required to press on the fingerprint sensor or alternatively on a keypad of the card for a predetermined duration. To display a temporary or dynamic virtual account number, the cardholder may be required to utilize the fingerprint sensor or keypad of the card device by double-pressing in a particular area or by pressing in rapid succession. Other methods are within the scope of the invention.

The memory 130 may include any of a variety of structures including an EEPROM or volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or being operated by the microprocessor 120. The data or program modules may include an operating system, application programs, other program modules, and program data. In addition, the instructions and/or data used in the practice of the invention may utilize any compression or encryption technique or algorithm, as may be desired. An encryption module might be used to encrypt data. Further, files or other data may be decrypted using a suitable decryption module.

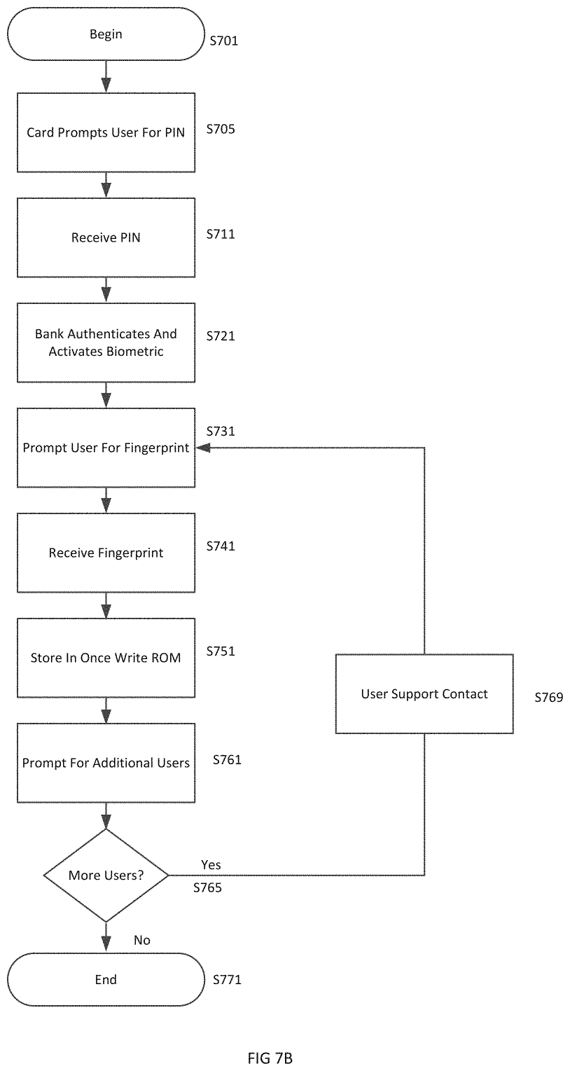

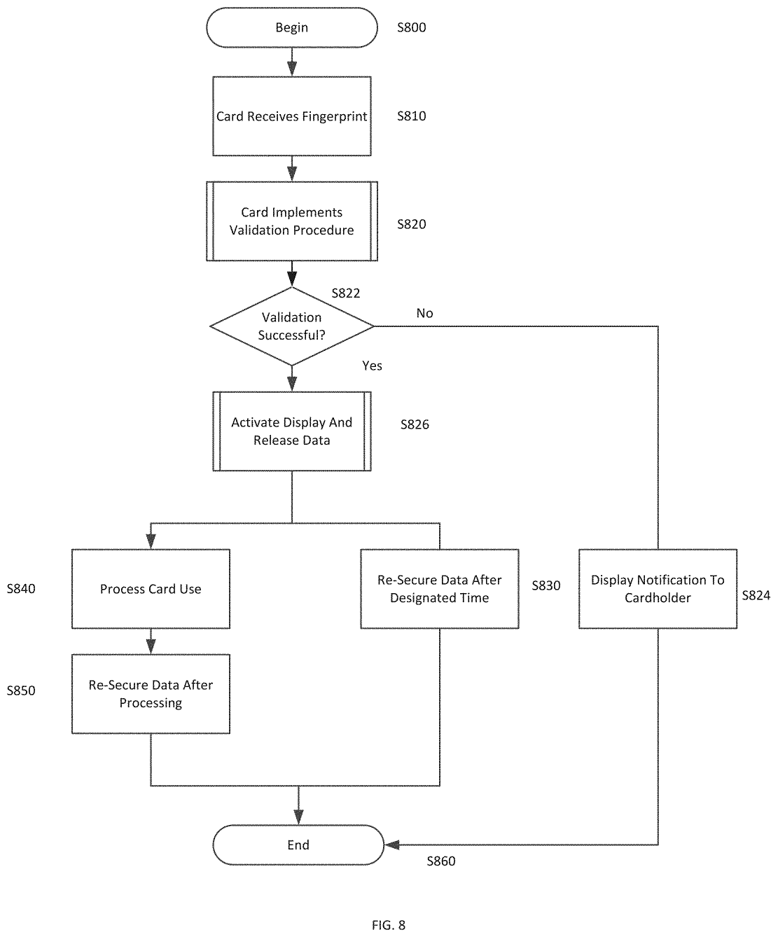

At minimum, the memory 130 includes at least one set of instructions that are either permanently or temporarily stored. The microprocessor 120 executes the instructions that are stored in order to process data. The set of instructions may include various instructions that perform a particular task or tasks, such as those shown in the flowchart of FIGS. 7 and 8. Such a set of instructions for performing a particular task may be characterized as a program, software program, software, engine, module, component, mechanism, or tool. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript for example. Further, it is not necessary that a single type of instruction or programming language be utilized in conjunction with the operation of the system and method of the invention. Rather, any number of different programming languages may be utilized as is necessary or desirable.

The data release circuit 140 is energized upon prompting by the microprocessor 120 and operates to release secure cardholder data upon successful authentication of the cardholder by the biometric sensor 110 and the microprocessor 120. If the authentication is unsuccessful, the microprocessor does not energize the data release circuit. In the case of the EMV chip, the data release circuit 150 unlocks the chip. In the case of the magnetic stripe, the data release circuit may activate a usable stored data sequence. For example, the magnetic stripe may store a scrambled number that is unscrambled through operation of the data release circuit. Alternatively, the magnetic stripe or multiple magnetic stripes may store two numbers including one inoperative decoy number as well as the correct account number. Prior to authentication, the inoperative number is active. Upon authentication, for a limited time period, the data release circuit activates the operative number. The data release circuit 140 may be a switching circuit suitable for use on a secure card device. While the data release circuit is described herein as a separate component, its functionality may alternatively be performed by the microprocessor 110 through suitable programming stored in the memory. The data release circuit 140 may include magnetic rods aligned to a predetermined position programmed for the particular card device. In this instance, successful authentication causes a change in polarization that re-aligns the magnetic rods to accurately convey account information through the secure card device. Alternatively, the data release circuit 150 causes a dynamic magnetic strip to display an appropriate code upon successful authentication.

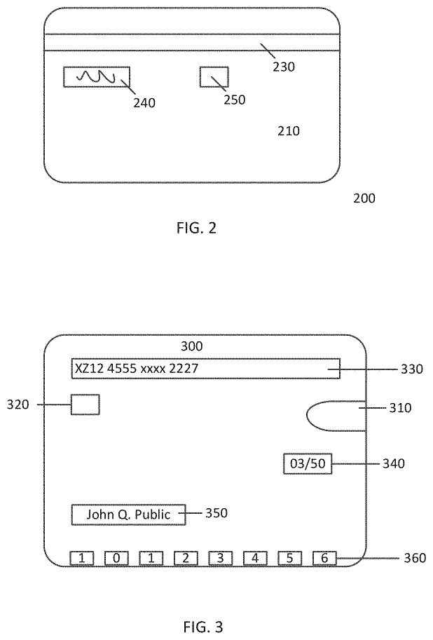

The display controller 150 operates upon successful authentication by the microprocessor 120 and data release by the data release circuit 140 in order to display confidential cardholder information on at least one planar face of the secure cardholder device as will be described further below with reference to FIGS. 2-5. In embodiments of the invention, the display controller allows the display to show the account number, CVV code, expiration date, and cardholder name. In some embodiments of the invention, account numbers may be dynamically generated by the microprocessor 120 so that a different account number is used for each transaction. In this instance, the primary card number is never shown on the display. In embodiments of the invention, the display controller 150 also displays transaction details of transactions performed with the card on the display 156.

The display 156 may be a transparent display panel formed from substrates or films having a liquid crystal display area, light emitting diodes, or the like disposed between them. In one preferred embodiment, the display is an ultra-thin LCD display. Thus, the display 156 may include a light emitting component that causes the displayed information to become visible through the transparent display panel. The electronic display 156 may alternatively be an electrophoretic display, electronic-ink type display or a display mechanism using micro-balls. The electronic display 103 must be sufficiently streamlined to be integrated into the secure card device and preferably also has low power requirements. Displays that imprint images should be avoided in order to enhance the security of the device.

The power supply 160 may include a battery, a solar panel, or other known type of miniaturized power supply suitable for inclusion a secure card device. The power supply may be a compact battery such as an ultra-slim profile battery that can be integrated into the secure card device. Depending on the required life of the card and the consumption of the microprocessor and other components, a rechargeable or non-rechargeable battery may be chosen. In alternative embodiments of the invention, no power supply may be provided and the secure card may receive its power through induction, NFC, or from a reader device.

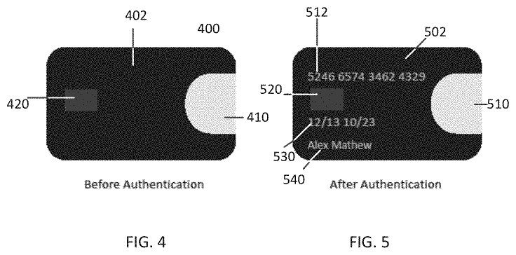

The user input interface 170 may allow use input through a touch pad as will be further described with reference to FIGS. 2 and 3. User input may be for the purpose of initial activation of the secure card device, such as through a PIN number. In embodiments of the invention, the user input interface may also be utilized to perform other operations, such as providing a PIN for POS purchases if desired by particular merchants. The user input interface 170 may be included in some embodiments of the invention, but in other embodiments may be omitted and replaced with centralized functionality requiring the cardholder to interface with the card issuer online, via telephone, in person, or through alternative channels.

In embodiments of the invention, various components described above may be included on a single integrated circuit chip embedded in the card substrate. For example, the contact interface 102, the microprocessor 120, the memory 130, the data release circuit 140, the display controller 150 and the user input interface 170 may be located on an IC chip while the display 156, biometric sensor 110, and power supply 160 may be or include separate components. Further, these components may interface with other displays, input devices, and chips embedded in the substrate and/or displayed on one of the planar surfaces of the secure card device.

FIG. 2 is a rear plan view of a secure card device 200 in accordance with an embodiment of the invention. The secure card device 200 may include a rear face 210 including a magnetic stripe 230, a signature block 240, and a CVV code 250. In embodiments of the invention, the CVV code 250 may be embodied by a display device as described above, such that the CVV code is not displayed until successful authentication by the microprocessor 120 and the biometric sensor 110.

FIG. 3 is a front plan view of a front planar face 300 of the secure card device 100 in accordance with an embodiment of the invention. The front planar face 300 of the secure card device 100 may include a biometric sensor 310, a chip 320, display areas 330, 340, and 350, and user input mechanisms 360.

As described above, the biometric sensor 310 is preferably a fingerprint sensor and may be or include any fingerprint sensor usable with the secure card device described herein. The chip 320, such as an EMV chip, may be positioned within the card substrate so as to be visible on the surface of the card. The contact interface 102 shown in FIG. 1 may be in communication with the chip 320 to enable locking and unlocking of the chip in accordance with embodiments of the invention. Alternative chip mechanisms are within the scope of the invention. The contact interface 102 may also interface with the magnetic stripe 230 shown in FIG. 2 to ensure communication with the microprocessor 120.

The display areas 330, 340, and 350 are specific areas of the card provided for display confidential cardholder information upon successful authentication. Accordingly, until the cardholder self-authenticates with a fingerprint, the confidential information such as the account number, the expiration date, the CVV code, and the cardholder name will not be visible. In embodiments of the invention, display areas need not be provided for all of the fields noted above. However, the display area 330 is necessarily provided for the account number so that the account number will not be visible unless a successful authentication process has been performed. Additionally, in embodiments of the invention, a single display area for displaying all of the confidential information upon successful authentication may be provided centrally on the front face 300 of the secure card 100.

The user input mechanism 360 may be or include a keypad for allowing a user to enter letters, numbers, or symbols. In embodiments of the invention, this user input mechanism 360 may be provided for initial activation of the secure card. For example, in embodiments of the invention, the card issuer may transmit a secure PIN, for example via email or text message, and the cardholder may be required to enter the secure PIN in order to activate the secure card. The input keypad may include a membrane or touch area on a surface of the secure card interconnected with the electronic components described above. A user may enter commands and information to the microprocessor through the user interface that is shown as a keypad but may alternatively include other input devices such as a microphone, voice recognition device, keyboard, touch screen, toggle switch, pushbutton, or the like. These and other input devices may be connected to the user input interface that is coupled to a system bus or other structure.

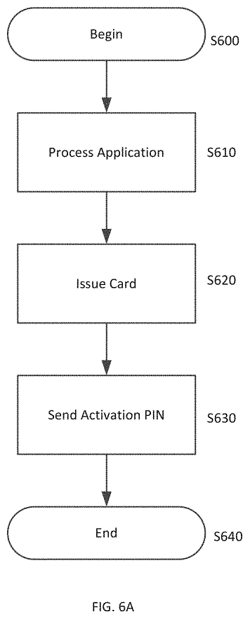

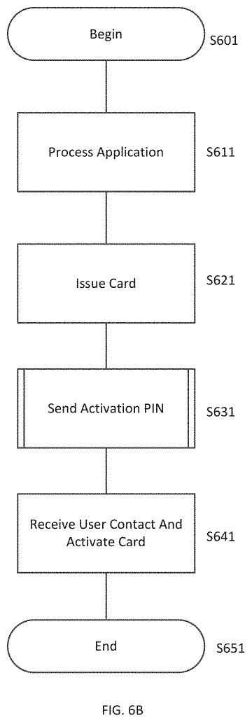

FIG. 4 is a front view of a secure card device 400 prior to authentication in accordance with an embodiment of the invention. Prior to authentication, the secure card device 400 appears essentially as having a black or dark surface 402. To achieve this appearance, the substrate itself may be covered by a dark coating and covered by a transparent film. The only visible components on the un-activated card are the chip component 420 and a biometric sensor 410. In order to utilize the secure card device 400, the cardholder presses a finger on the biometric sensor 410. Upon sensing the presence of a finger, the microprocessor compares the applied fingerprint to a fingerprint stored in the memory of the secure card device 400. If the fingerprint is not a match, the secure card device 400 does not change appearance and is not usable. Alternatively, the secure card device 400 may flash all zeros or perform another similar action upon a bad print read or lack of a match. However, if the fingerprint matches the stored fingerprint, the secure card information becomes visible on a surface of the secure card device as shown in FIG. 5.

FIG. 5 is a front view of the secure card device 400 of FIG. 4 upon self-authentication by the cardholder. The card surface 502 remains dark. However, confidential cardholder information is illuminated so that it may be used for transactions. The cardholder information may, for example, be embodied by an LED display that is illuminated upon successful authentication. As illustrated, an account number 512, expiration date 530, and cardholder name are displayed. The CVV code may be displayed on a rear or front planar face of the secure card device. A chip 520 and a biometric sensor 510 remain visible.

Thus, as illustrated, the secure cardholder information becomes visible upon successful authentication. Thus, it is only upon successful authentication that the card can be used for card not present transactions such as internet purchases and telephone purchases. However, approximately simultaneously with the display of the secure cardholder information, the EMV chip and/or magnetic stripe containing the secure cardholder information become usable at the point of sale through operation of the data release circuit. The secure information may be available for a limit time period, such as for example, thirty seconds, or one minute subsequent to activation. Other time periods are within the scope of the invention.

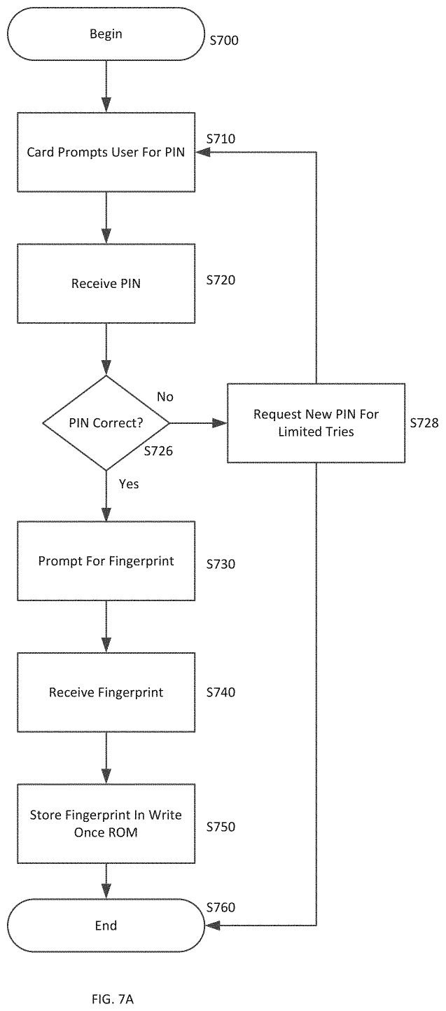

FIG. 6A is a flow chart illustrating a card issuance process in accordance with an embodiment of the invention. The process begins in S600 and the issuer processes an application for a secure card device in S610. Upon approval of the application, the issuing institution issues the secure card device in S620 and sends the card to the applicant. In S630, in an additional transmission, the issuing institution sends an activation PIN to the cardholder. The process ends in S640.

FIG. 6B is a flow chart illustrating a card issuance process in accordance with an alternative embodiment of the invention. In this embodiment, the cardholder interfaces with the card issuer or central management platform in order to complete the issuance process. The process begins in S601 and the issuer processes an application for a secure card device in S611. Upon approval of the application, the issuing institution issues the secure card device in S621 and sends the card to the applicant. In S631, in an additional transmission, the issuing institution sends an activation PIN to the cardholder. In S641, the card issuer receives the PIN from the cardholder. The cardholder may, for example, utlize the PIN to authenticate to a central management system. For example, the cardholder may visit a website or call a provided telephone number to activate the card. The process ends in S651

FIG. 7A is a flowchart illustrating a card activation process in accordance with an embodiment of the invention. In S700 the card prompts the user for a PIN. In S720, the system receives the entered PIN through the provided keypad and input interface. Assuming that the entered PIN is a match to the card, the card prompts the cardholder for a fingerprint in S720.

If the received PIN is not match to the card in S726, the user may be re-prompted in S728. After one or more additional efforts, the card may power down if the PIN is incorrect.

When the PIN matches the issued card and the card prompts the user for a fingerprint in S730, the user inputs the fingerprint in S740 and the card stores the fingerprint in memory, such as a once writeable ROM in S750. Thus, the captured fingerprint stored in the memory will function as the comparison print for future attempted transactions.

FIG. 7B is a flowchart illustrating a card activation process in accordance with an alternative embodiment of the invention in which the cardholder interfaces with a central management system in order to activate the card. Additionally, the process illustrated in FIG. 7B can be utilized in order to add multiple authorized users to the card account. The process begins in S701. In S705, the card prompts the user for a PIN. In S711, the system receives the entered PIN at a central management system, for example, through user contact over the Internet, via text message, or via telephone. In S721 the central management system, which may be located at the bank issuing the secure card, activates the biometric features of the card.

The card prompts the user for a fingerprint in S731, the user inputs the fingerprint in S741 and the card stores the fingerprint in memory, such as a once writeable ROM in S751. Thus, the captured fingerprint stored in the memory will function as the comparison print for future attempted transactions. Additionally, the system may prompt for additional users at S761. If there are no additional users in S765, the process ends in S771. If there are additional users, the cardholder contacts customer support in S769 so that users can be added. The contact with customer support can be, for example, by telephone or over the Internet.

Thus, in embodiments of the invention, multiple user profiles may be associated with a single secure card device. Each time another user profile is added to a secure card device, the issuing entity may send a secure PIN to allow the new user to activate the card and store the new user fingerprint.

FIG. 8 is a flowchart illustrating processing within the secure card device upon user self-authentication for performance of a transaction. The process begins in S800 and the card receives the user fingerprint through the biometric sensor in S810. In S820, the card implements a validation procedure. As set forth above, the validation procedure occurs when the microprocessor receives input fingerprint data from the biometric sensor and compares the input fingerprint data to the fingerprint data that was stored in ROM upon card activation. If the validation is unsuccessful in S822, the card may provide a notification to the cardholder in S824. For example, the card device may flash zeros or an alternative indicator to indicate that the attempt to validate was unsuccessful. The card powers down and no transaction is performed. If the validation is successful in S822, the card releases the secure cardholder data and activates the display in S826. As set forth above, in embodiments of the invention, a data release circuit releases secure data stored in the memory, the magnetic stripe, and/or the chip. Thus, contact mechanisms such as the chip and the magnetic stripe become usable so that a transaction can be performed at the POS.

The above-described methods for authentication are not intended to be limiting. For example, in addition to the methods described above, a mobile phone can be paired with the secure card to provide additional authentication layers. The mobile phone may be paired with the secure card using techniques such as NFC or Bluetooth. The mobile device may execute a mobile application that allows for authentication using finger printing, iris scanning, voice texture, and/or facial recognition.

With respect to the magnetic stripe, several embodiments are within the scope of the invention. For example, as set forth above, a scrambled account number may be stored while the card is deactivated and the data release circuit may operate to unscramble the account number. Alternatively, a decoy account number may be stored in an un-activated state and it may be replaced by a legitimate account number when activated. One or more magnetic stripes may store the data. With respect to the chip, the chip may remain in a locked stated prior to authentication and the data release circuit may operate to unlock the chip for use. As set forth above, these steps may alternatively be performed by a programmed microprocessor.

Also upon successful validation, the display controller activates the display so that the account number, expiration date, cardholder name, and CVV code are shown on the rear surface of the card. As, in embodiments of the invention, it is not necessary for the display to by altered, this information can be emblazoned on the card and illuminated for use. Thus, each time the card activates, identical information is displayed. However, when the card is in an inactive states, the faces of the card remain blank so that unauthorized “card not present” transactions cannot be performed. In other embodiments, such as when dynamically generated single transaction account numbers are used, the display is dynamically generated pursuant to each authentication.

After the card has been activated for use, it is operable for a limited duration, which may be the shorter of a pre-set time period or use of the card for a transaction. For example, the card may be activated for three minutes unless it is used for a transaction, in which case it will be de-activated immediately after processing, for example in ninety seconds rather than three minutes.

For example, during a transaction at a POS, if the secure card device contains an EMV chip with a communication interface in accordance with the standard ISO 7816, the secure card device is inserted in a secure reader. Depending on the merchant, the reader may require inclusion of a PIN in addition to the fingerprint. Furthermore, a mobile device could be required to execute multi-factor authentication if the card is in an unknown location. The reader verifies the PIN number entered by the holder of the card or the multi-factor authentication provided by the mobile device to verify that the card holder identity, followed by the exchange of secure information via encrypted messages between the card, the reader and possibly a remote server to verify whether the debit is authorized. Upon completion of the transaction, the chip is de-activated.

Accordingly, as shown in S840, the system processes card use and re-secures the data in S850 upon transaction processing. However, if no usage occurs after activation, the card re-secures the data after a designated time, for example two to five minutes after activation. The process ends in S860.

It should also be readily apparent to one of ordinary skill in the art that the presently disclosed invention may be implemented in a wide range of industries. The various embodiments and features of the presently disclosed invention may be used in any combination, as the combination of these embodiments and features are well within the scope of the invention. While the foregoing description includes many details and specificities, it is to be understood that these have been included for purposes of explanation only, and are not to be interpreted as limitations of the present invention. It will be apparent to those skilled in the art that other modifications to the embodiments described above can be made without departing from the spirit and scope of the invention. Accordingly, such modifications are considered within the scope of the invention as intended to be encompassed by the following claims and their legal equivalent.

From the foregoing, it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

1. A secure card for facilitating protection of secure information belonging to a cardholder, the secure card comprising:
a biometric interface configured to receive, from the cardholder, an input that is usable for executing a self-authentication of the card;
a memory storing instructions and information pertaining to the cardholder;
a card body connected with the memory, the card body including at least one planar face configured to communicate the secure information upon self-authentication by the cardholder through the biometric interface,
a data release circuit configured to release the secure information upon execution of the self-authentication by the cardholder; and
a display controller that is implemented by a processor and, when the secure information has been released, is configured to activate a light-emitting diode (LED) display to cause the secure information to be visibly illuminated from the at least one planar surface of the card body.

2. (canceled)

3. The secure card of claim 1, wherein the display controller is further configured to deactivate the LED display when an earlier one of a transaction being processed and three minutes elapsing occurs.

4. (canceled)

5. The secure card of claim 1, wherein the secure information is not visible prior to the execution of the self-authentication by the cardholder.

6. The secure card of claim 1, wherein the card further comprises a keypad for initial activation, wherein the card is configured to prompt the user for a personal identification number (PIN) and to prompt the user for a fingerprint upon receiving the PIN through the keypad.

7. The secure card of claim 6, wherein the memory includes a write once read-only memory (ROM) configured to cause the fingerprint to be stored only once in the memory.

8. The secure card of claim 1, further comprising a magnetic stripe on the at least one planar surface of the card, the magnetic stripe being configured to store the secure information and to cause the secure information to be unreadable prior to the execution of the self-authentication by the cardholder.

9. The secure card of claim 8, wherein when the secure information is scrambled prior to the execution of the self-authentication, the data release circuit is further configured to unscramble the secure information upon the execution of the self-authentication.

10. The secure card of claim 8, wherein when the secure information is locked prior to the execution of the self-authentication, the data release circuit is further configured to unlock the secure information upon the execution of the self-authentication.

11. The secure card of claim 10, wherein the data release circuit is further configured to unlock the secure information for a time period that is limited to a time during which a cardholder finger is in contact with the biometric sensor.

12. The secure card of claim 1, further comprising an EMV chip for performing transactions, wherein the EMV chip is locked prior to the execution of the self-authentication and is unlocked upon the execution of the self-authentication.

13. A method for completing a secure transaction using a secure card for facilitating protection of secure information belonging to a cardholder, the method comprising:
receiving input from the cardholder through a biometric interface on a card body, the card body including at least one planar face for communicating the secure information belonging to the cardholder upon self-authentication by the cardholder through the biometric interface allowing the cardholder to self-authenticate to the card;
utilizing a memory connected with the card body, the memory storing instructions and information pertaining to the cardholder to compare the received input through the biometric interface to stored biometric information in order to authenticate the cardholder;
activating a data release circuit for releasing the secure information upon self-authentication by the cardholder; and
causing the secure information to be readable from the at least one planar surface of the card body using a display controller responsive to the data release circuit.

14. The method of claim 13, further comprising a providing a display panel disposed on the at least one planar face, wherein display controller activates the display to reveal the secure information upon self-authentication by the cardholder.

15. The method of claim 14, further comprising activating the display using the display controller for a limited duration upon self-authentication.

16. The method of claim 15, wherein the limited time is the earlier of receipt of a transaction request based on the card and three to five minutes from self-authentication.

17. The method of claim 13, further comprising concealing all cardholder information on the planar face prior to self-authentication by the cardholder.

18. The method of claim 13, further comprising initially activating the card using a keypad for initial activation, wherein the card prompts the user for a PIN and prompts the user for a fingerprint upon receiving the PIN through the keypad.

19. The method of claim 18, further comprising writing the fingerprint to memory including a write once ROM enabling the fingerprint to be stored only once in the memory.

20. The method of claim 13, further comprising storing the secure information on a magnetic stripe on the at least one planar surface of the card, wherein the secure information is unreadable until self-authentication by the cardholder.

21. The method of claim 20, further comprising scrambling the secure information until the self-authentication by the cardholder and unscrambling the secure information upon self-authentication for a limited duration.

22. The method of claim 20, wherein the secure information is locked until the self-authentication and is unlocked for a limited time after self-authentication.

23. The method card of claim 20, wherein the secure information is unlocked for a time period limited to the time the cardholder finger is in contact with the biometric sensor.

24. The method of claim 13, further comprising unlocking an EMV chip disposed on the secured card upon successful authentication.
